(19) United States
(12) Patent Application Publication
(10) Pub. No.: US 2005/0076068 A1
(43) Pub. Date: Apr. 7, 2005

(54) System and method of synchronizing data in multi-user computer network

(76) Inventors: Paul C. Fowler, Phoenix, AZ (US); Atul Brad Buono, Tempe, AZ (US); Leonid Epshtein, Phoenix, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 10/667,805

(22) Filed: Sep. 22, 2003

(51) Int. Cl. G06F 12/00

(52) U.S. Cl. 707/201

(57) ABSTRACT

A multi-user computer network (10) has multiple remote workstations (12, 26, 28) connected to a network server (22). The workstations access records from a database (32) controlled by the network server. All workstations can have the same record (42) open with full read and write privileges. When one workstation wants to make a change, a request is made to the network server to change the record. The network server authorizes the change to the record. The change to the record is make available to the other workstations to keep all users synchronized to the same version of the record. The network server operates as coordinator of the database allowing simultaneous changes while maintaining the latest version of the records at all workstations which utilize the record.

### FIELD OF THE INVENTION

The present invention relates in general to computer networks and, more particularly, to a system and method of synchronizing data in a multi-user computer network.

### BACKGROUND OF THE INVENTION

Individuals and businesses commonly use computer systems and networks to store, access, and manipulate data. A typical computer network system includes one or more workstations connected to a server over a communication network. The server usually has a hard disk drive to store large amounts of data useful to the business. The server hard disk provides central storage of information accessible by authorized users at remote workstations. The central storage of information provides a common point of access for the users, more cost effective use of resources, easier maintenance of the data, and enhanced security.

The server hard disk can be used to store financial information, marketing information, product designs, customer information, personnel records, medical records, manufacturing data, research and development data, and other information useful to the business. The business information is often organized as one or more related records stored in a relational database or flat file for easy access, organization, and management. Application software residing on the server, or residing on the workstation and communicating through the server, accesses the business information stored in the database. The information can be used for a variety of business functions such as project management, bidding and estimation, financial reporting, reservation systems, document control, government compliance, manufacturing control systems, and new product designs.

A user operating from a workstation accesses the desired information stored on the server database as one or more related records. The information is downloaded from the server to the workstation where the user can review, analyze, and make changes to the data as needed. When the work is done, any new information or edits to the prior information are copied back from the workstation to the server database to overwrite and update the record(s).

The server-based computer network becomes more complicated when multiple users need to access the records stored on the computer system simultaneously. Assume a first user operating from a first workstation accesses a record or file from the server database. The record is downloaded from the server database to the first workstation. Further assume a second user operating from a second workstation wants to access the same record while the first user has the record open. A conflict may arise when two users want to review and edit the same record at the same time.

Prior art computer networks have used several approaches to manage the potential conflicts. One approach is to allow both users to download the same record from the server database to their respective workstations. When it comes time to write the modified record back to the server database, the user is notified that another user also has the same record checked-out and is given the option of discarding changes or overwriting the database record in view of the other user. Generally, the server database reflects what the last user in time chooses to overwrite. The second user will be using “old data” in the local workstation once the first user saves the modified record back to the server database. The first user having previously saved data may have his or her data overwritten by the second user saving data later in time. Obviously, well-established rules, procedures, and etiquette are needed to avoid conflicts between users and corruption of data.

Another approach is to grant full access including write privileges only to the first user to request access to a particular record or file. The first user is allowed to check-out the record with full privileges. If other users want to access the same record, while it is checked-out by the first user, they are limited to downloading the record in read only mode, i.e. the second read only user will not be allowed to make edits. In this case, the system prevents simultaneous edits from multiple users by granting write privileges only to the first in time user. When the first user checks the record back into the server database, the record becomes available for full access by another authorized user.

A significant shortcoming of the read only mode approach is that the users checking out the record in read only mode may not be getting the most recent version of the record considering edits that may have been made by the first user since the full access check-out. Even if the first user saves edits to the server database to update the record before the read only user downloads the record, any change made to the record by the first user after that fact will again not be available to the read only user. The read only user has no assurance of downloading the most recent version of the record or being notified if and when edits are made. The read only user may be working with and making decisions based on incorrect or old information. Using out-of-date information can be inefficient and costly in business and create safety concerns and liability issues.

### SUMMARY OF THE INVENTION

In one embodiment, the present invention is a method of synchronizing data in a multi-user computer network comprising accessing a record from a database for a first user, accessing the record from the database for a second user, requesting a first change to the record by the first user, receiving an authorization to make the first change to the record, and making the first change to the record accessible to the second user.

In another embodiment, the present invention is a method of synchronizing data in a multi-user computer network comprising accessing a record from a database for a first user, making a first change to the record, processing the first change to the record through a controller of the database, and making the first change to the record accessible to a second user.

In yet another embodiment, the present invention is a method of utilizing data in a multi-user computer system comprising accessing a record from a database to perform a first function on a first network node, accessing the record from the database to perform a second function on a second network node, processing a first change to the record on the first network node, and making the first change to the record accessible to the second network node.

### BRIEF DESCRIPTION OF THE DRAWINGS

FIG. 1 is a block diagram of a multi-user network computer system;

FIG. 2 illustrates multiple users operating from separate workstations accessing records from a common database on the network server;

FIG. 3 illustrates the steps of synchronizing data in a multi-user computer network; and

FIG. 4 illustrates further steps of synchronizing data in a multi-user computer network.

### DETAILED DESCRIPTION OF THE DRAWINGS

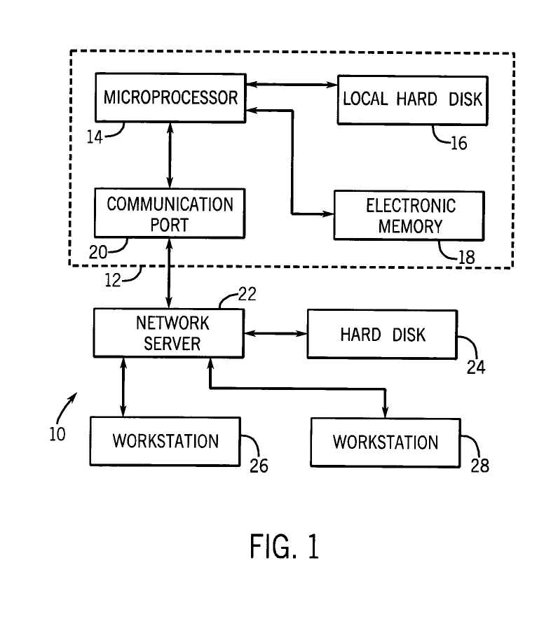

A multi-user computer network 10 is shown in FIG. 1. Computer system or workstation 12 is a general purpose computer including a central processing unit or microprocessor 14, mass storage device or hard disk 16, electronic memory 18, and communication port 20. Communication port 20 may be a high speed Ethernet connection to network server 22. Network server 22 stores information on hard disk 24. Hard disk 24 is a high capacity drive to store large amounts of information. Workstation 26 and workstation 28 are configured as shown for workstation 12 and are also connected by high speed communication link to network server 22. Workstations 12, 26, and 28 are examples of network nodes that can send and/or receive information. Other types of network nodes that can be connected to the communication network include dedicated data processing terminals. Workstations 12, 26, and 28 and other network nodes can, via network server 22, read and store information on hard disk 24.

Computer network 10 is useful to individuals and businesses to store, access, and manipulate data. Business and personal data is stored on hard disk 24. The data is arranged as one or more related records stored in database 32 residing on hard disk 24 for easy access, organization, and management. Database 32 can be a relational database, any flat file, or other organized data storage. Hard disk 24 provides central storage of information accessible by authorized users at workstations 12, 26, and 28. Network server 22 operates as the controller of hard disk 24 and database 32. That is, all requests for access to database 32 go through network server 22. The central storage of information provides a common point of access for the users, more cost effective use of resources, easier maintenance of the data, and enhanced security.

The database can be used to store financial information, marketing information, documents, product designs, customer information, personnel records, medical records, manufacturing data, technical data, research and development data, and other information useful to a business or individual. Application software residing on network server 22, or residing on workstations 12, 26, and 28 and communicating through the network server, accesses the business information stored in the database. The information can be used for a variety of business functions such as project management, bidding and estimation, financial reporting, reservation systems, document control, government compliance, manufacturing control systems, and new product designs.

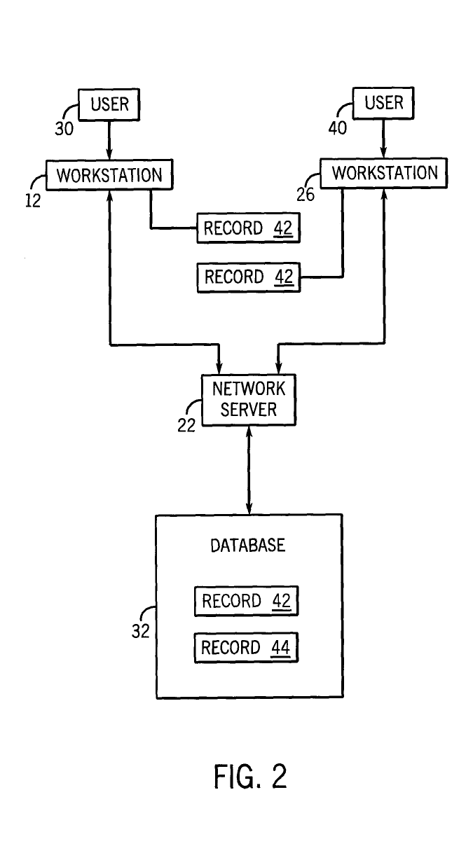

Turning to FIG. 2, user 30 operates workstation 12. From time to time, user 30 sends a request to network server 22 to access the certain information stored in database 32. Database 32 resides on hard disk 24 under control of network server 22. The request from user 30 may involve retrieving one or more records, or downloading a file, from database 32. The requested data is retrieved from database 32 by network server 22 and downloaded or transferred by way of communication link 20 to workstation 12. Application software such as a word processor, spreadsheet, project management, or financial analysis tool, residing workstation 12 uses microprocessor 14, local hard disk 16, and electronic memory 18 to review, analyze, utilize, perform calculations, print, add new information, and make edits to the data as needed.

In a similar manner, user 40 operates workstation 26. From time to time, user 40 sends a request to network server 22 to access the certain information stored in database 32. The request from user 40 may involve retrieving one or more records, or downloading a file, from database 32. The requested data is retrieved from database 32 by network server 22 and downloaded to workstation 26. Application software residing on workstation 26 uses microprocessor-like 14, local hard disk-like 16, and electronic memory-like 18 to review, analyze, utilize, perform calculations, print, add new information, and make edits to the data as needed.

Consider the case where user 30 requests record 42 from database 32. Record 42 represents any related group of words or set of information such as a name, address, phone number, date, numeric value, financial data, bidding data, estimation, description, and notation and may exist in the form of a record, job, report, and file. Record 42 can be part of a series of records in database 32. Network server 22 retrieves record 42 from database 32 and sends the data to workstation 12. Network server 22 logs record 42 as being checked-out from database 32 by user 30. The log used by network server 22 to keep track of checked-out records can reside in electronic memory, database 32, or other file on hard disk 24.

Assume for the present discussion that record 42 is part of a series of records related to bidding and estimation of a construction project. In this case, record 42 is a numeric value of an interest rate related to and involved with the bidding and estimation function for the construction project. A value of 7% for record 42 is retrieved from database 32 and sent to workstation 12 for user 30. Workstation 12 performs calculations and other analysis with the 7% value of record 42.

User 30 decides to make an edit to record 42 and change the value of the interest rate to 6%. For now, user 30 is the only user that has record 42 checked-out. User 30 enters 6% with the keyboard, which then appears on the computer screen for workstation 12. The application software running on workstation 12 then uses the new 6% interest rate to re-calculate relevant bidding and estimation values for the construction project. Each and every statement, bid, estimation, report, process, or file on workstation 12 now uses the new value for the interest rate as modified from record 42.

When user 30 enters the new value for the interest rate, a notice, indicator, or change request of the proposed new value for record 42 is sent to network server 22. Network server 22 may handle the new value of the interest rate in several different ways. In one process, network server 22 checks database 32 or reviews its own history to see which user(s) have record 42 checked-out. Network server 22 then broadcasts the new value for record 42 to all users that have the record check-out. Network server 22 further saves the change to record 42 until such time as database 32 is formally updated.

In another process, network server 22 provides additional administrative functions. The new value for record 42 is viewed as a change request which must be approved by network server 22. Again, network server 22 checks database 32 or reviews its own history to see which user(s) have record 42 checked-out. In the present discussion, only user 30 has checked-out record 42. Network server checks a variety of administrative functions to determine if the change to record 42 by user 30 is appropriate and would not corrupt or compromise the integrity of the system. For example, if computer network 10 is experiencing technical difficulties which could corrupt the present transaction, or if there is any abnormality with user 30, then network server 22 may disregard or disapprove the change request. The change request can be disapproved if user 30 does not have the requisite authority to make changes or if the change would otherwise corrupt or compromise the system. If user 30 has full access, including write privileges to database 32 and record 42, and the change would not adversely impact the system, and all other formalities are in order, e.g. computer network 10 operating normal, then the proposed change request is approved by network server 22 and a change authorization for record 42 is stored on network server 22. The change authorization is also sent from network server 22 to workstation 12 to confirm the approved change from the 7% interest rate to the 6% interest rate for record 42.

At this point, user 30 may or may not have expressly saved record 42 back to database 32, e.g. by selecting the save function from the application software in use. The status of record 42 is in an intermediate state. The original record 42 in database 32 may still show 7% for the interest rate, but network server 22 has approved the change to record 42 and made a note of its new value. Workstation 12 is operating with the change to record 42 in effect. Before user 30 finishes his or her session, network server 22 will require a formal update to database 32, i.e. save the change to record 42 back into database 32, or give user 30 the option of rescinding the approved edits.

Multiple users routinely access the information stored in database 32. In many situations, more than one user may want access to the same record. Each user should have access to the most up-to-date information and latest version of the desired record. Moreover, more than one user may want to make edits to the same record in approximately the same time frame, i.e. during the same time that another user has the same record open. Multi-user computer network 10 allows any user to gain full access to any record at any time, including the ability to make edits, independent of other users accessing the same record. This feature has significant advantages. Each user has the same sense that their session and work is first priority. Computer network 10 manages simultaneous edits being made by multiple users and coordinates changes to the records in database 32 so that each user has access to the most recent information available on the system.

Any proposed change to a record is provided to network server 22, which in turn processes, coordinates, and manages the edits to database 32 being made by one or more users. Network server 22 operates as the clearing-house for proposed changes for a particular record or records from multiple users, processes the proposed changes for the record(s), and updates the changes to other users who are accessing or utilizing the record(s) in question. Network server 22 can record and keep track of the change to a record in its own electronic memory in the form of a table or histogram showing which users have checked-out which records and which records have been changed. Alternatively, network server 22 can keep track of the record changes in database 32 or other file on hard disk 24.

Continuing the present example, now assume that after user 30 has requested and received authorization from network server 22 to change record 42 from 7% interest rate to 6% interest rate, user 40, operating from workstation 26, requests access to record 42. In ordinary circumstances, network server 22 retrieves record 42 from database 32 and sends the data to workstation 26. Network server 22 logs record 42 as being checked-out from database 32 by user 40. Record 42 would be available to application software residing on workstation 26 such as word processors, spreadsheets, project management routines, and financial analysis tools, to review, analyze, utilize, perform calculations, print, add new information, and make changes to the data as needed.

In the present situation, network server 22 recognizes that record 42 has already been checked-out by user 30. One of the functions of network server 22 is to ensure that user 40 gets the most recent version of record 42, including any changes made by user 30 which have been processed or approved by network server 22. Since user 30 has noticed network server 22 of the change to record 42 and having requested and received authorization to change record 42, network server 22 may require user 30 to update database 32, i.e. perform a forced save of record 42 back to database 32. User 40 can then get the most up-to-date version of record 42 directly from database 32. Alternatively, network server 22 may get the original information for record 42 from database 32. Network server 22 would then delete, insert, and change the information in record 42 to reflect the edits made by user 30 before forwarding the updated record 42 to workstation 26. In another embodiment, network server 22 may get the base information for record 42 from database 32 and send the original record 42 and the approved edits made by user 30 to workstation 26. Workstation 26 then consolidates the original record 42 from database 32 with the approved edits to get the latest version of record 42. In yet another embodiment, workstation 26 gets the original record 42 from database 32 along with the notice that user 30 has made edits. Workstation 26 then get the edits to record 42 directly from workstation 12. In any case, user 40 gets record 42 as modified by user 30. Workstation 26 now has access to the most recent information for record 42 and can perform operations accordingly.

If, while user 40 has record 42 open, user 30 makes a second change to record 42, then a similar process occurs. The second change involves changing the interest rate to 5%. The requested change is sent from workstation 12 to network server 22. As discussed above, network server 22 may simply transfer or broadcast the change to all users, including user 40, that have record 42 open. In other cases, network server 22 treats the change as a request which must be confirmed. Network server 22 verifies that user 30 has the right and authority to make the requested change, that the change will not corrupt database 32, and that all other formalities are in order. Network server 22 approves the requested change and forwards the change authorization back to workstation 12. The application software on workstation 12 executes with the 5% interest rate.

In addition, since user 40 has record 42 checked-out, the approved change is also sent to workstation 26 with the instruction that the new 5% interest rate for record 42 is in effect. The application software on workstation 26 begins executing based on the new 5% interest rate. The application software on workstation 26 may re-run spreadsheets, re-calculate bids and estimation, modify reports, change files, post notices, and make other changes and updates according to its programmed functions all based on the new 5% interest rate. The change in interest rate from record 42 as made by user 30 is immediately reflected in the application software of workstation 26, and any other workstation making use of record 42, without any special action by user 30 or user 40. User 40 sees the information on his or her workstation change in real-time with changes being made by another user, i.e. user 30, operating from another workstation. Workstation 26 has access to and is executing on the most recent information for record 42.

The similar process is available for user 40. Assume users 30 and 40 both check-out record 44 which contains pricing information related to materials to be used on the construction project. If user 40 needs to make a change to record 44, e.g. to reflect a price increase, while user 30 still has the record open, then the change request is sent from workstation 26 to network server 22. Assume user 40 wants to change the price of materials to be used in bidding a prospective job. Network server 22 may simply transfer or broadcast the change to all users, including user 30, that have record 44 open. In addition, network server 22 may verify that user 40 has the right and authority to make the requested change, that the change would not compromise the system, and that all other formalities are in order. Network server 22 approves the requested change and forwards the change authorization back to workstation 26. The application software running workstation 26 executes with the new pricing information concerning record 44.

In addition, since user 30 has record 44 open, the approved change is also sent to workstation 12 with the instruction that new pricing for record 44 is in effect. The application software on workstation 12 begins executing based on the new pricing of materials. The application software on workstation 12 may re-run spreadsheets, re-calculate bids and estimation, modify reports, change files, post notices, and make other changes and updates according to its programmed functions all based on the new pricing of materials. The change in pricing from record 44 as made by user 40 is immediately reflected in the application software of workstation 12, and any other workstation making use of record 44, without any special action by user 30 or user 40. User 30 sees the information on his or her workstation change in real-time with changes being made by another user, i.e. user 40, operating from another workstation. Workstation 12 has access to and is executing on the most recent information for record 44.

In the above described process, computer network 10 has provided real-time synchronization of the data being accessed and changed by multi-users. Multiple users can have access to a common record from database 32 and make simultaneous edits, at least in terms of each user being able to make changes with other users having the same record checked-out. Any change in a particular record or group of records, which as been requested by one user and approved by the database controller, e.g. network server 22, is immediately made available to all users who have the subject record(s) checked-out. Each user workstation then re-executes its application software based on the new information. The process may involve hundreds or thousands of calculations, replacements, estimations, and simulations with each user workstation acting on the new data. The burden of making the necessary changes to the overall business functions resides with the individual workstations, as is designed for computer network 10, without loading network server 22. It is the change in a record by one user and subsequent approval by the database controller that triggers the transfer of new information for the record to the other users and re-execution of the application software on the remote workstations in accordance with the new information. Each user workstation on computer network 10 is synchronized with every other user workstation such that all workstations are executing application software with the same data, taking into account any change made by any user on the network.

Network server 22 contains change procedures and instructions to complete one change request/approval transaction before starting another. If user 30 requests to change the interest rate in record 42 to 6%, and user 40 makes a request to change the interest rate in record 42 to 6.5% while network server 22 is still processing the request from user 30, then network server 22 will finish the change request and approval for user 30 before starting any processing for the change request from user 40. Network server 22 suspends processing of any other change request related to a specific record until any pending change request for that same record is complete. Once the first change request is complete, network server 22 processes the second change request in due course, independent of first change request. Thus, if user 30 is first in time with a change request and user 40 is second, then users 30 and 40 will see the interest rate change to 6% as per user 30's request, and then shortly after finishing the change request for user 30, the users will see the interest rate change to 6.5% as per user 40's request.

Anytime one user who has approved changes pending on network server 22 makes an express save of the record with changes back to database 32, e.g. by selecting the save function from the application software in use, all users who have approved changes pending on network server 22, at least for the same record, are required to save their respective changes back to database 32. The forced save policy provides a general system clean up from time to time which simplifies the administration of database 32 and reduces errors.

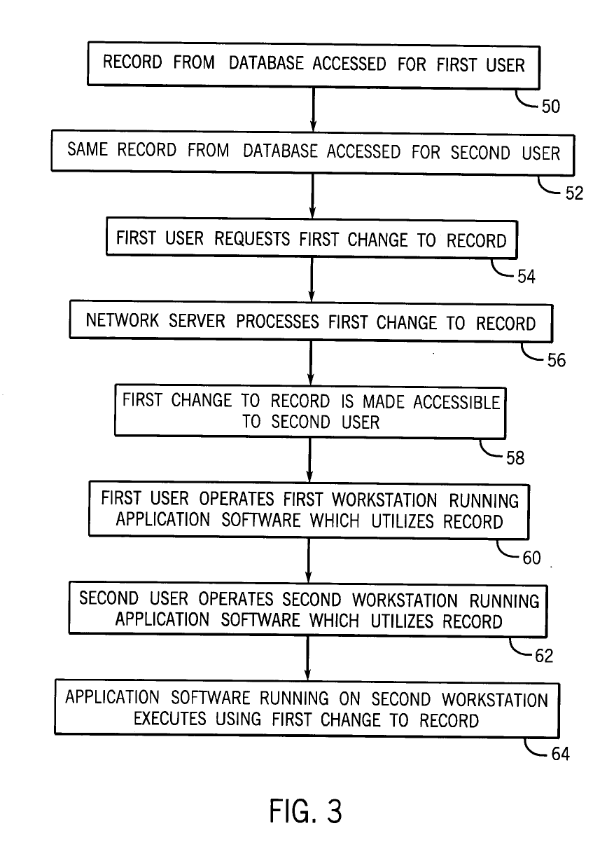

The steps of synchronizing data in multi-user computer network 10 is described in FIG. 3. In step 50, a record from a database is accessed for a first user. In step 52, the same record from the database is accessed for a second user. In step 54, the first user requests a first change to the record. In step 56, the network server processes the first change to the record. In step 58, the first change to the record is made accessible to the second user. In step 60, the first user operates a first workstation running application software which utilizes the record. In step 62, the second user operates a second workstation running application software which utilizes the record. In step 64, the application software running on the second workstation executes using the first change to the record.

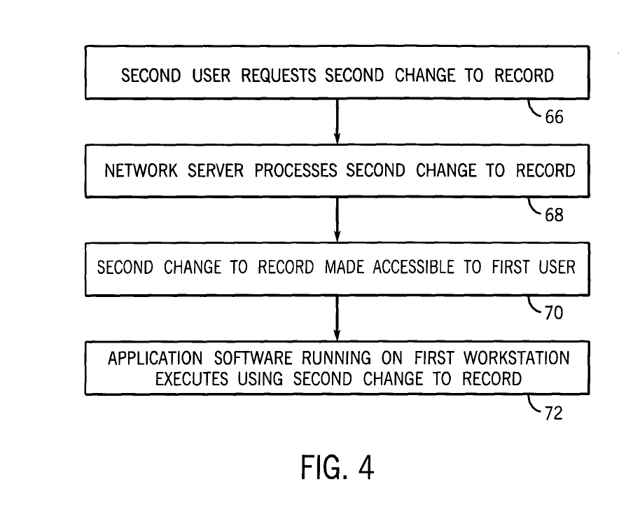

Continuing with the steps of synchronizing data in multi-user computer network 10 in FIG. 4, in step 66, the second user requests a second change to the record. In step 68, the network server processes the second change to the record. In step 70, the second change to the record is made accessible to the first user. In step 72, the application software running on the first workstation executes using the second change to the record.

The advantages available with computer network 10 are significant. Most business projects of any size and significance are handled by a team of individuals. It is common for one team member to have new information which could be of benefit to other team member(s). Consider a construction project where a first team member gets a more favorable interest rate from the bank, or learns of a price increase or decrease for the construction materials. Rather than making several telephone calls, or sending a flurry of emails, which might not be received or understood, the first team member simply enters the new information in his or her workstation. Once the change is approved by the network server, all other team members automatically get access to and are synchronized with the new information. The chief estimator might want to change the bid based on the new information to improve the prospect of winning the job or making the project more profitable. The other team members might not even know that a change occurred, but each would automatically be running application software and making decisions based on the latest information.

Consider another example where a health care provider learns of critical information related to patient care. Using computer network 10, each member of the team providing patient care would have the latest information and be able to provide accurate diagnosis and recommend the most beneficial treatment. For example, if the lab finds an unknown medical condition from certain test results, the new information for the patient record could immediately be made available to the doctors and nurses. Situations adverse to the patient's best interest could be avoided.

In a research and development environment, a change to the product design parameters by one user is immediately reflected on the system and made available to other design team members. If, for example, the weight of the new product changes, the other design team members will have the new weight parameters as soon as the network server approves the change.

In the travel reservation industry, an increase in certain variable costs made by one user can be reflected as soon as possible to all users of the reservation system in making quotes to customers. Computer network 10 would accept the price increase and reflect the new costs to all agents making reservations.

In another embodiment of computer network 10, the database may be stored on one workstation. The records are then downloaded from one workstation to other workstations. In this case, the workstation storing the database would perform the task of the network server in terms of receiving a change request and granting authorization to change a record in the database.

A person skilled in the art will recognize that changes can be made in form and detail, and equivalents may be substituted, for elements of the invention without departing from the scope and spirit of the invention. The present description is therefore considered in all respects to be illustrative and not restrictive, the scope of the invention being determined by the following claims and their equivalents as supported by the above disclosure and drawings.

1. A method of synchronizing data in a multi-user computer network, comprising:
accessing a record from a database for a first user;
accessing the record from the database for a second user;
requesting a first change to the record by the first user;
receiving an authorization to make the first change to the record; and
making the first change to the record accessible to the second user.

2. The method of claim 1 wherein the database is stored on a hard disk operating under control of a network server.

3. The method of claim 2 wherein the step of requesting the first change to the record is made to the network server.

4. The method of claim 3 wherein the authorization for the first change to the record is made by the network server.

5. The method of claim 4 wherein the step of making the first change to the record available to the second user is executed by the network server.

6. The method of claim 1 wherein the first user operates a first workstation running application software which utilizes the record and the second user operates a second workstation running application software which utilizes the record.

7. The method of claim 6 wherein the application software running on the second workstation executes using the first change to the record.

8. The method of claim 1 further including:
requesting a second change to the record by the second user;
receiving an authorization to make the second change to the record; and
making the second change to the record available to the first user.

9. A method of synchronizing data in a multi-user computer network, comprising:
accessing a record from a database for a first user;
making a first change to the record;
processing the first change to the record through a controller of the database; and
making the first change to the record accessible to a second user.

10. The method of claim 9 further including the step of accessing the record from the database for a second user.

11. The method of claim 10 wherein the database is stored on a hard disk operating under control of a network server.

12. The method of claim 11 wherein the step of requesting the first change to the record is made to the network server.

13. The method of claim 12 wherein the authorization for the first change to the record is made by the network server.

14. The method of claim 13 wherein the step of making the first change to the record accessible to a second user is executed by the network server.

15. The method of claim 10 wherein the first user operates a first workstation running application software which utilizes the record and the second user operates a second workstation running application software which utilizes the record.

16. The method of claim 15 wherein the application software running on the second workstation executes using the first change to the record.

17. The method of claim 10 further including:
requesting a second change to the record by the second user;
receiving an authorization to make the second change to the record; and
making the second change to the record available to the first user.

18. A multi-user computer system, comprising:
means for accessing a record from a database for a first user;
means for accessing the record from the database for a second user;
means for requesting a first change to the record by the first user;
means for receiving an authorization to make the first change to the record; and
means for making the first change to the record available to the second user.

19. The multi-user computer system of claim 18 further including:
a network server controlling the database;
a first workstation coupled to the network server and running application software which utilizes the record; and
a second workstation coupled to the network server and running application software which utilizes the record.

20. The multi-user computer system of claim 19 wherein the application software running on the second workstation executes with the first change to the record upon receiving the first change to the record.

21. The multi-user computer system of claim 18 further including:
means for requesting a second change to the record by the second user;
means for receiving an authorization to make the second change to the record; and
means for making the second change to the record available to the first user.

22. A method of utilizing data in a multi-user computer system, comprising:
accessing a record from a database to perform a first function on a first network node;
accessing the record from the database to perform a second function on a second network node;
processing a first change to the record on the first network node; and
making the first change to the record accessible to the second network node.

23. The method of claim 22 wherein the database is stored on a hard disk operating under control of a network server.

24. The method of claim 23 wherein the authorization for the first change to the record is made by the network server.

25. The method of claim 24 wherein the step of making the first change to the record accessible to the second network node is executed by the network server.

26. The method of claim 22 wherein the first workstation runs application software which utilizes the record and the second network node runs application software which utilizes the record.

27. The method of claim 26 wherein the application software running on the second network node to execute using the first change to the record.

28. The method of claim 22 wherein the first and second functions involve bidding and estimation on a construction project.
